(19) United States
(12) Patent Application Publication
(10) Pub. No.: US 2003/0178265 A1
(43) Pub. Date: Sep. 25, 2003

(54) Brake disk for a vehicle wheel

(75) Inventor: Chao-Ying Chen, Tainan Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Alex Machine Industrial Co., Ltd., Tainan Hsien (TW)

(21) Appl. No.: 10/163,229

(22) Filed: Jun. 4, 2002

(30) Foreign Application Priority Data
Mar. 21, 2002 (TW) 091203507

(51) Int. Cl. B62L 5/00

(52) U.S. Cl. 188/218 XL; 188/26

(57) ABSTRACT

A brake disk includes a disk body with an inner ring portion adapted to be coupled to a wheel hub, an outer ring portion disposed around the inner ring portion and adapted to be in frictional contact with a brake pad, and a plurality of connecting ribs extending between and interconnecting the inner and outer ring portions. Each of the connecting ribs has a reinforcing portion which projects relative to one of two opposite side surfaces of the disk body.

### BACKGROUND OF THE INVENTION

1. Field of the Invention

The present invention relates to a brake disk for a vehicle, such as a bicycle or a motorcycle, more particularly to a reinforced vehicle brake disk.

2. Description of the Related Art

Referring to FIGS. 1 and 2, a conventional brake disk 1 is to be installed on one side of the hub (not shown) of a vehicle wheel, such as a bicycle wheel or motorcycle wheel. By virtue of frictional contact with a brake pad (not shown) disposed adjacent to the vehicle wheel, the brake disk 1 can stop or decelerate rotation of the vehicle wheel. The brake disk 1 is in the form of a circular disk made of stainless steel or aluminum alloy. In order to reduce the weight and the cost of material, the brake disk 1 is designed to have a hollowed-out configuration and includes an inner ring 11 formed around a central axis 10 thereof, an outer ring 12 disposed concentrically around the inner ring 11, and a plurality of connecting ribs 12 extending between and interconnecting the inner and outer rings 11, 12. The inner ring 11 confines a coupling hole 111 for coupling with the hub, and is formed with a plurality of fastener holes 112 for extension of fasteners therethrough so as to fasten the brake disk 1 to the hub. The outer ring 13 is to be disposed in frictional contact with the brake pad, and is formed with a plurality of bores 131 to increase the friction with the brake pad. Slots 121 are defined among the inner and outer rings 11, 13 and adjacent ones of the connecting ribs 12. It was found that, due to the presence of the fastener holes 112 in the inner ring 11, the slots 121 among the connecting ribs 12, and the bores 131 in the outer ring 13, the strength of the brake disk 1 is weakened. The brake disk 1 is susceptible to deformation and vibration when the brake pad is applied thereto during use of the brake disk 1 on a vehicle wheel.

### SUMMARY OF THE INVENTION

Therefore, the main object of the present invention is to provide a brake disk with a reinforced configuration.

Accordingly, the brake disk of the present invention is adapted to be mounted on a wheel hub, and includes a disk body with opposite first and second side surfaces. The disk body includes an inner ring portion adapted to be coupled to the wheel hub, an outer ring portion disposed around the inner ring portion and adapted to be in frictional contact with a brake pad, and a plurality of connecting ribs extending between and interconnecting the inner and outer ring portions. Each of the connecting ribs has a reinforcing portion which projects relative to one of the first and second side surfaces of the disk body.

### BRIEF DESCRIPTION OF THE DRAWINGS

Other features and advantages of the present invention will become apparent in the following detailed description of the preferred embodiments with reference to the accompanying drawings, of which:

FIG. 1 is an elevational view of a conventional brake disk for a vehicle;

FIG. 2 is a cross-sectional view of the brake disk of FIG. 1;

FIG. 3 is an elevational view of a first preferred embodiment of the brake disk according to the present invention;

FIG. 4 is a cross-sectional view of the first preferred embodiment, taken along line IV-IV of FIG. 3;

FIG. 5 is a cross-sectional view of a second preferred embodiment of the brake disk according to the present invention;

FIG. 6 is a cross-sectional view of a third preferred embodiment of the brake disk according to the present invention; and

FIG. 7 is a cross-sectional view of a fourth preferred embodiment of the brake disk according to the present invention.

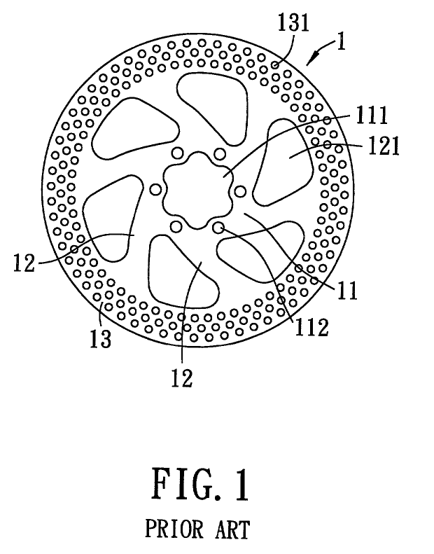

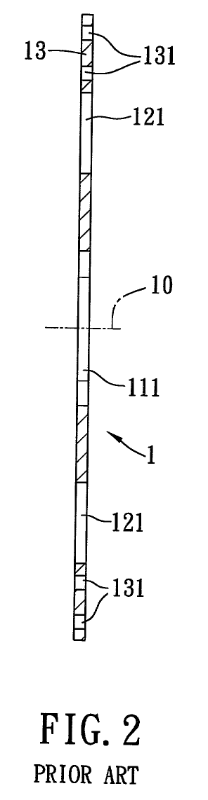

### DETAILED DESCRIPTION OF THE PREFERRED EMBODIMENTS

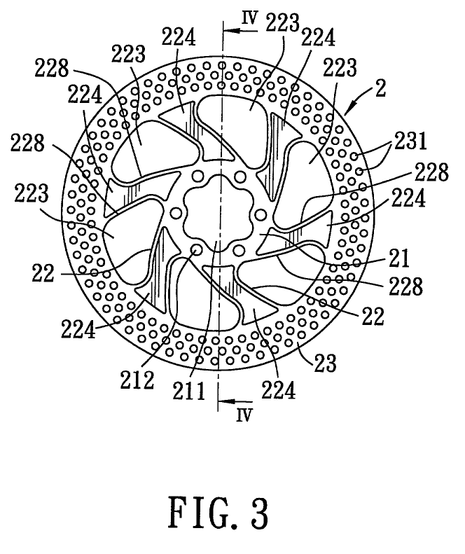

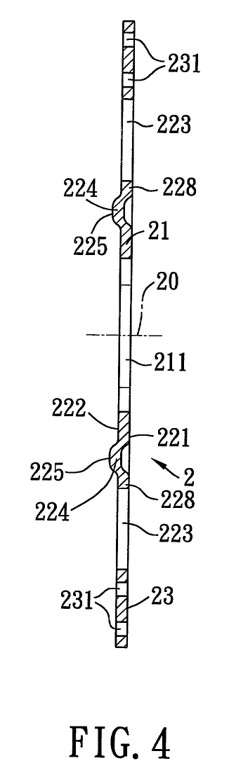

The brake disk according to the present invention is adapted to be installed on a hub (not shown) of a vehicle wheel, such as a bicycle wheel or a motorcycle wheel, and is adapted to be in frictional contact with a brake pad (not shown) that is provided adjacent to the vehicle wheel. Referring to FIGS. 3 and 4, the first preferred embodiment of the brake disk 2 according to the present invention is shown to be in the form of a circular metal disk body with a central axis 20 and opposite first and second side surfaces 222, 221. The second side surface 221 is an inner side of the brake disk 2 and faces the vehicle wheel. The brake disk 2 includes an inner ring portion 21 adapted to be coupled to the hub, an outer ring portion 23 disposed concentrically around the inner ring portion 21, and a plurality of connecting ribs 22 interconnecting the inner and outer ring portions 21, 23. The inner ring portion 21 confines a central coupling hole 211 adapted to be coupled with the hub, and is formed with a plurality of fastener holes 212 around the coupling hole 211 for extension of fasteners therethrough so as to fasten the inner ring portion 21 to the hub. The outer ring portion 23 is formed with a plurality of bores 231 to increase friction between the outer ring portion 23 and the brake pad. The connecting ribs 22 are circumferentially spaced-apart from one another, and thus define a plurality of slots 223 that are formed among the inner and outer ring portions 21, 23 and the connecting ribs 22 and that are formed through the first and second side surfaces 222, 221. Each of the connecting ribs 22 is formed between two of the slots 223, and has two opposite rim portions 228 which extend between the inner and outer ring portions 21, 23 and which define peripheries of two adjacent ones of the slots 223. The rim portions 228 are curved and extend along the peripheries of the two adjacent ones of the slots 223. Each of the connecting ribs 22 has a reinforcing portion 224 formed by punching. In this embodiment, the reinforcing portion 224 on each of the connecting ribs 22 projects relative to the first side surface 222, and is recessed relative to the second side surface 221 so as to impart increased strength to the brake disk 2. The reinforcing portion 224 on each of the connecting ribs 22 extends among the rim portions 228 of the respective connecting rib 22 and the inner and outer ring portions 21, 23. In the present embodiment, each of the reinforcing portions 224 has a flat surface 225 which is raised relative to the first side surface 222.

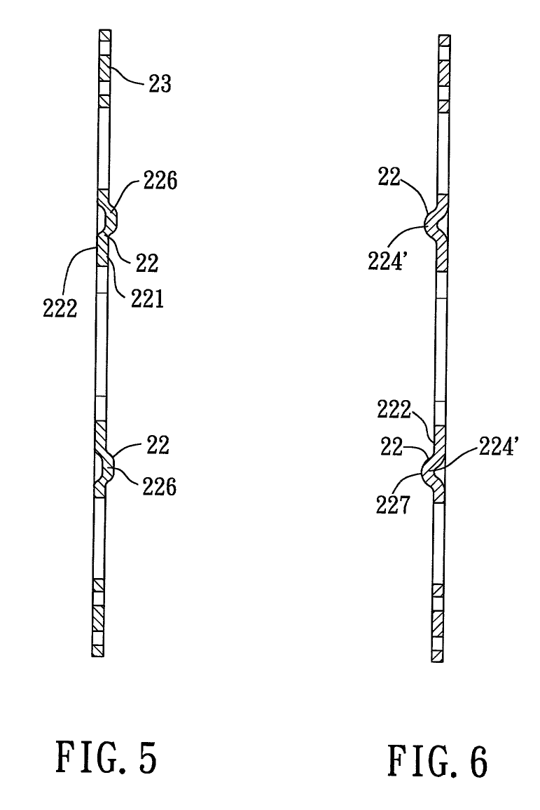

Referring to FIG. 5, the brake disk of the second preferred embodiment according to the present invention is shown to be generally similar to the previous embodiment in configuration, except that the reinforcing portions 226 on the connecting ribs 22 project relative to the second side surface 221 and are recessed relative to the first side surface 222.

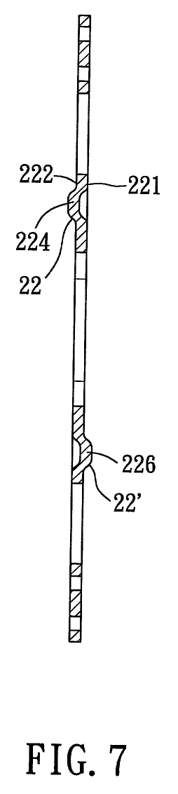

Referring to FIG. 6, the brake disk of the third preferred embodiment according to the present invention is shown to be similar to the first preferred embodiment in configuration, except that each of the reinforcing portions 224′ on the connecting ribs 22 has a convex surface 227 which is raised relative to the first side surface 222.

Referring to FIG. 7, in the brake disk of the fourth preferred embodiment, the connecting ribs include a first rib set and a second rib set. The connecting ribs 22 of the first rib set are each formed with a reinforcing portion 224 that projects relative to the first side surface 222 and that is recessed relative to the second side surface 221. The connecting ribs 22′ of the second rib set are each formed with a reinforcing portion 226 that projects relative to the second side surface 221 and that is recessed relative to the first side surface 222.

By forming the reinforcing portions 224, 226, 224′, the connecting ribs 22, 22′ are provided with projecting and recessed parts, such that the strength of the brake disk of this invention can be significantly enhanced without increasing the weight of the brake disk and the cost of material for producing the brake disk.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A brake disk adapted to be mounted on a wheel hub, said brake disk comprising:
a disk body having opposite first and second side surfaces, said disk body including
an inner ring portion adapted to be coupled to the wheel hub,
an outer ring portion disposed around said inner ring portion and adapted to be in frictional contact with a brake pad, and
a plurality of connecting ribs extending between and interconnecting said inner and outer ring portions, each of said connecting ribs having a reinforcing portion which projects relative to one of said first and second side surfaces of said disk body.

2. The brake disk as claimed in claim 1, wherein said connecting ribs are circumferentially spaced-apart from one another and define a plurality of slots among said inner and outer ring portions and said connecting ribs, said slots being formed through said first and second side surfaces, each of said connecting ribs being formed between two of said slots.

3. The brake disk as claimed in claim 2, wherein each of said connecting ribs has two opposite rim portions which extend between said inner and outer ring portions and which respectively define peripheries of two adjacent ones of said slots, said reinforcing portion on each of said connecting ribs extending among said inner and outer ring portions and said rim portions of a respective one of said connecting ribs.

4. The brake disk as claimed in claim 1, wherein said reinforcing portion has a flat surface which is raised relative to said first side surface.

5. The brake disk as claimed in claim 1, wherein said reinforcing portion has a convex surface which is raised relative to said first side surface.

6. The brake disk as claimed in claim 1, wherein said reinforcing portion on each of said connecting ribs is recessed relative to another one of said first and second side surfaces.

7. The brake disk as claimed in claim 6, wherein said reinforcing portion on each of said connecting ribs is formed by punching.

8. The brake disk as claimed in claim 1, wherein said connecting ribs include a first rib set and a second rib set, said reinforcing portions on said connecting ribs of said first rib set projecting relative to said first side surface, said reinforcing portions on said connecting ribs of said second rib set projecting relative to said second side surface.

9. The brake disk as claimed in claim 8, wherein said reinforcing portions on said connecting ribs of said first rib set are recessed relative to said second side surface, said reinforcing portions on said connecting ribs of said second rib set being recessed relative to said first side surface.
